(19) United States
(12) Patent Application Publication
(10) Pub. No.: US 2024/0133811 A1
(43) Pub. Date: Apr. 25, 2024

(54) METHODS, COMPUTER PROGRAMS AND APPARATUS FOR ESTIMATING A POSITION OF AN EMITTER OR A REFLECTOR IN A SAMPLE

(71) Applicant: ABBERIOR INSTRUMENTS GMBH, Gottingen (DE)

(72) Inventor: Roman SCHMIDT, Goettingen (DE)

(21) Appl. No.: 18/389,944

(22) Filed: Dec. 20, 2023

Related U.S. Application Data
(63) Continuation-in-part of application No. PCT/EP2022/067102, filed on Jun. 23, 2022.

(30) Foreign Application Priority Data
Jun. 25, 2021 (DE) 10 2021 116 504.0

(51) Int. Cl. G01N 21/64; G02B 21/00

(52) U.S. Cl. CPC G01N 21/6458; G02B 21/0076

(57) ABSTRACT

Methods, computer programs with instructions, and apparatus for estimating a position of an emitter or reflector in a sample are disclosed. Also disclosed are microscopes using a method or an apparatus according to the present principles. In the method, the sample is illuminated with excitation light at at least one set of target coordinates. Fluorescence photons or reflected photons are detected for the individual target coordinates of the set of target coordinates. A position of an emitter or reflector is estimated from the detected fluorescence photons or reflected photons. The estimation of the position of the emitter or reflector comprises a comparison of estimated positions determined from subsets of the set of target coordinates. Alternatively, the excitation light has an intensity distribution having a central minimum and three or more local maxima arranged around the central minimum, wherein the angular positions of the three or more local maxima change along the optical axis.

### CROSS-REFERENCE TO RELATED APPLICATIONS

The present application is a continuation-in-part application and claims priority to and the benefit of International Patent Application No. PCT/EP2022/067102, filed on Jun. 23, 2022, and further claims priority to and the benefit of German Patent Application DE 10 2021 116 504.0, filed on Jun. 25, 2021, the entire contents of which are incorporated herein by reference.

### BACKGROUND OF THE INVENTION

### a. Field of the Invention

The present disclosure relates to methods, computer programs with instructions, and apparatus for estimating a position of an emitter or reflector in a sample. The present disclosure also relates to microscopes using such a method or such an apparatus.

### b. Description of the Prior Art

Fluorescence microscopy has experienced a boost in terms of the achievable resolution thanks to the synergetic combination of the specific strengths of coordinate-targeted and coordinate-stochastic, i.e. in particular single-molecule-based, super-resolution microscopy methods and nanoscopy methods. Coordinate-oriented super-resolution microscopy methods are, for example, STED (STimulated Emission Depletion) and RESOLFT (REversible Saturable OpticaL Fluorescence Transitions). Coordinate-stochastic super-resolution microscopy methods include PALM (PhotoActivated Localization Microscopy)/STORM (STochastic Optical Reconstruction Microscopy) and PAINT (Point Accumulation for Imaging in Nanoscale Topography). The nanoscopy method resulting from the combination, called MINFLUX (MINimal photon FLUXes), has closed the existing resolution gap of ˜20-30 nm in STED, PALM/STORM, and other fluorescence nanoscopy methods to the order of magnitude of the molecules themselves in the range of 1-5 nm.

At its core, MINFLUX localization is based on the basic idea of injecting a reference coordinate into the sample by using a structured optical beam, e.g. a donut with a central intensity minimum, i.e. a zero point. The position of the zero point in the sample defines the targeted sample coordinate. The MINFLUX concept applies equally to whole sets of reference coordinates, i.e. line-shaped and point-shaped zero points, and to parallelized detection in the wide field. The targeting of coordinates enables a controlled and thus photon-efficient localization of fluorescence molecules, because the fluorophore coordinate to be determined is no longer determined by determining the center of a weak, diffraction-limited fluorescence spot captured by a camera. Instead, the fluorophore is localized by actively aligning the zero point of the excitation light with the fluorophore. Specifically, the zero point of the excitation light is moved as close as possible to the molecule in several iterations until the detected fluorescence rate corresponds approximately to that of the background noise. At this closest proximity, only a minimal number of fluorescence photons are needed to achieve maximum localization precision, since determining the remaining distance between the coordinate targeted by the zero point and the molecule position requires far fewer detected photons. Thus, “injecting” or targeting a reference coordinate shifts the requirement of many fluorescence photons for localization to the virtually unlimited number of photons in the excitation light.

Since MINFLUX localization is no longer limited by the requirement of a large number of fluorescence photons, this nanometer-precise localization is much faster than the camera-based localization used in PALM/STORM. The idea of optically injecting a coordinate with the aid of a zero point is also present in principle in the original STED concept. In STED microscopy, in the absence of background noise, a single detected photon is sufficient to detect the presence of a fluorophore at the coordinate targeted by the zero point. There, too, the emitting fluorophore is precisely localized by the photons injected by the STED light.

One possible approach for MINFLUX localization uses iterative localization. In this approach, the position of an emitter in a sample is derived from photon counts measured at a series of positions by applying a stochastic estimator to the data. In order to obtain an unbiased result, i.e. a result without systematic error, a measurement scheme is used that provides a nearly unbiased localization in real time.

For a target coordinate pattern with m beam positions \vec{b}ᵢ(i=0 . . . m−1) and associated photon counts pᵢ, the position u can be estimated, for example, using an uncalibrated symmetric estimator as follows:

$$\vec{u} ( \vec{x} , {\vec{b}}_{i} ) = \vec{u} ( {p}_{i} ( \vec{x} ) , {\vec{b}}_{i} ) = \frac{{\sum }_{i = 0}^{m - 1} {p}_{i} \cdot {\vec{b}}_{i}}{{\sum }_{i = 0}^{m - 1} {p}_{i}} . \qquad ( 1 )$$

Further information on this estimator can be found, for example, in F. Balzarotti et al.: “Nanometer resolution imaging and tracking of fluorescent molecules with minimal photon fluxes,” Science 355, pp. 606-612 (2017).

A simulation is used to determine the systematic deviation between the actual position of a fluorophore and the position determined by the estimator. The deviation determined in this way is used to calibrate the estimator, i.e. for a MINFLUX measurement, the raw estimated value is corrected by the deviation so that an estimated value is obtained from the measurement that no longer has a bias.

This works if each uncalibrated estimated value is associated with exactly one actual position of a fluorophore. This condition is fulfilled if there is certainty that a fluorophore is actually located within a certain range of the target coordinate pattern. If a fluorophore is located further outside, the estimated value can again be identical to an estimated value obtained for the inner area. Therefore, if the actual position of the fluorophore is known with insufficient certainty before the measurement, no clear estimate of the position of the fluorophore can be obtained from the subsequent measurement.

In other words, the position estimation of the above estimator is not injective with respect to x→u even under perfect conditions, i.e. infinite photons, no background noise. It is only injective for |x|≤xₗᵢₘ. To avoid ambiguities, measures must therefore be taken to ensure that the emitters to be located are always at radial distances of less than x hm from the center of the target coordinate pattern.

Using the MINFLUX approach, not only emitters can be localized, but also reflecting particles. This is particularly useful for detecting any drift that may be present. When localizing such reflectors, the above-mentioned problem also arises.

### SUMMARY OF THE INVENTION

Methods, computer programs and apparatus for estimating a position of an emitter or reflector in a sample are disclosed. Also disclosed are microscopes using such a method or such an apparatus.

According to one aspect, a method for estimating a position of an emitter or reflector in a sample comprises:
illuminating the sample with excitation light at at least one set of target coordinates;
detecting fluorescence photons or reflected photons for the individual target coordinates of the set of target coordinates; and
estimating a position of an emitter or reflector from the detected fluorescence photons or reflected photons;
wherein estimating the position of the emitter or reflector comprises comparing vector sums and/or sums over vectors of the detected fluorescence photons or reflected photons determined for subsets of the set of target coordinates, and/or wherein the excitation light has an intensity distribution having a central minimum and three or more local maxima arranged around the central minimum, wherein the angular positions of the three or more local maxima change along the optical axis.

According to another aspect, a method for estimating a position of an emitter or reflector in a sample comprises:
illuminating the sample with excitation light at at least one set of target coordinates, wherein the excitation light has an intensity distribution in the form of a donut;
detecting fluorescence photons or reflected photons for the individual target coordinates of the set of target coordinates;
determining a first estimated position of an emitter or reflector from the fluorescence photons or reflected photons detected for a first subset of the set of target coordinates;
determining a second estimated position of the emitter or reflector from the fluorescence photons or reflected photons detected for a second subset of the set of target coordinates; and
estimating a position of the emitter or reflector by comparing the first estimated position and the second estimated position. Preferably, the first estimated position and the second estimated position are uncalibrated and the position estimated by comparing the first estimated position and the second estimated position is calibrated.

According to another aspect, a method for estimating a position of an emitter or reflector in a sample comprises:
illuminating the sample with excitation light at at least one set of target coordinates;
detecting fluorescence photons or reflected photons for the individual target coordinates of the set of target coordinates; and
estimating a position of an emitter or reflector from the detected fluorescence photons or reflected photons;
wherein the excitation light has an intensity distribution comprising a central minimum and three or more local maxima arranged around the central minimum, wherein the angular positions of the three or more local maxima vary along the optical axis. Preferably, estimating the position of the emitter or reflector comprises comparing estimated positions for the emitter or reflector determined from fluorescence photons or reflected photons detected for subsets of the set of target coordinates.

According to another aspect, a computer program comprises instructions that, when executed by a computer, cause the computer to perform the following steps for estimating a position of an emitter or reflector in a sample:
illuminating the sample with excitation light at at least one set of target coordinates;
detecting fluorescence photons or reflected photons for the individual target coordinates of the set of target coordinates; and
estimating a position of an emitter or reflector from the detected fluorescence photons or reflected photons;
wherein estimating the position of the emitter or reflector comprises comparing vector sums and/or sums over vectors of the detected fluorescence photons or reflected photons determined for subsets of the set of target coordinates, and/or wherein the excitation light has an intensity distribution having a central minimum and three or more local maxima arranged around the central minimum, wherein the angular positions of the three or more local maxima change along the optical axis.

According to another aspect, a computer program comprises instructions that, when executed by a computer, cause the computer to perform the following steps for estimating a position of an emitter or reflector in a sample:
illuminating the sample with excitation light at at least one set of target coordinates, wherein the excitation light has an intensity distribution in the form of a donut;
detecting fluorescence photons or reflected photons for the individual target coordinates of the set of target coordinates;
determining a first estimated position of an emitter or reflector from the fluorescence photons or reflected photons detected for a first subset of the set of target coordinates;
determining a second estimated position of the emitter or reflector from the fluorescence photons or reflected photons detected for a second subset of the set of target coordinates; and
estimating a position of the emitter or reflector by comparing the first estimated position and the second estimated position. Preferably, the first estimated position and the second estimated position are uncalibrated and the position estimated by comparing the first estimated position and the second estimated position is calibrated.

According to another aspect, a computer program comprises instructions that, when executed by a computer, cause the computer to perform the following steps for estimating a position of an emitter or reflector in a sample:
illuminating the sample with excitation light at at least one set of target coordinates;
detecting fluorescence photons or reflected photons for the individual target coordinates of the set of target coordinates; and
estimating a position of an emitter or reflector from the detected fluorescence photons or reflected photons;
wherein the excitation light has an intensity distribution comprising a central minimum and three or more local maxima arranged around the central minimum, wherein the angular positions of the three or more local maxima vary along the optical axis. Preferably, estimating the position of the emitter or reflector comprises comparing estimated positions for the emitter or reflector determined from fluorescence photons or reflected photons detected for subsets of the set of target coordinates.

The term computer is to be understood broadly. In particular, it also includes microcontrollers, embedded systems and other processor-based data processing devices. The steps mentioned can be carried out directly by the computer or by the computer controlling a component intended to carry out a step, for example a light source or a detector.

For example, the computer program may be provided for electronic retrieval or stored on a computer-readable storage medium.

According to another aspect, an apparatus for estimating a position of an emitter or reflector in a sample comprises:
illuminating means for illuminating the sample with excitation light at at least one set of target coordinates;
detecting means for detecting fluorescence photons or reflected photons for the individual target coordinates of the set of target coordinates; and
estimating means for estimating a position of an emitter or reflector from the detected fluorescence photons or reflected photons;
wherein the estimating means is configured to compare vector sums and/or sums over vectors of the detected fluorescence photons determined for subsets of the set of target coordinates in order to estimate the position of the emitter or reflector, and/or wherein the excitation light has an intensity distribution having a central minimum and three or more local maxima arranged around the central minimum, wherein the angular positions of the three or more local maxima change along the optical axis.

According to another aspect, an apparatus for estimating a position of an emitter or reflector in a sample comprises:
illuminating means for illuminating the sample with excitation light at at least one set of target coordinates, wherein the excitation light has an intensity distribution in the form of a donut;
detecting means for detecting fluorescence photons or reflected photons for the individual target coordinates of the set of target coordinates; and
estimating means for estimating a position of an emitter or reflector from the detected fluorescence photons or reflected photons;
wherein the estimating means is configured to determine a first estimated position of an emitter or reflector from the fluorescence photons or reflected photons detected for a first subset of the set of target coordinates, determine a second estimated position of the emitter or reflector from the fluorescence photons or reflected photons detected for a second subset of the set of target coordinates, and estimate a position of the emitter or reflector by comparing the first estimated position and the second estimated position. Preferably, the first estimated position and the second estimated position are uncalibrated and the position estimated by comparing the first estimated position and the second estimated position is calibrated.

According to another aspect, an apparatus for estimating a position of an emitter or reflector in a sample comprises:
illuminating means for illuminating the sample with excitation light at at least one set of target coordinates, wherein the excitation light has an intensity distribution comprising a central minimum and three or more local maxima arranged around the central minimum, wherein the angular positions of the three or more local maxima vary along the optical axis;
detecting means for detecting fluorescence photons or reflected photons for the individual target coordinates of the set of target coordinates; and
estimating means for estimating a position of an emitter or reflector from the detected fluorescence photons or reflected photons. Preferably, the estimating means is configured to compare estimated positions for the emitter or reflector determined from fluorescence photons or reflected photons detected for subsets of the set of target coordinates for estimating the position of the emitter or reflector.

In the solution according to the present principles, the size of the usable range within which the estimator implemented in the estimator is clearly assigned to an actual position can be increased through a comparison of vector sums or sums over vectors over subsets of the set of target coordinates. Additionally or alternatively, the use of a special intensity distribution makes it possible to determine depth information for the emitter or reflector as an additional parameter without having to shift the focal plane relative to the sample. Both allow faster localization of the emitter or reflector. Preferably, the vector sums are weighted vector sums. It is assumed that the vector sums are each made up of positive summands. Positive here means that no summand is assigned a negative weight. Equivalently, all weights could of course be negative. The direction vectors themselves can each have a negative or positive sign.

If the implemented estimator based on subsets of the set of target coordinates is used together with an intensity distribution in the form of a donut, one advantage of this estimator is that the capture range, i.e. the range in which a unique calibratable or calibrated position estimation is obtained, is larger. At the same time, however, a conventional estimator based on a vector sum over the complete set of target coordinates provides an estimate with higher accuracy if the emitter or reflector is clearly within the capture range of this estimator. Therefore, if the estimator based on subsets of the set of target coordinates provides a position well within the capture range of the conventional estimator, it is advantageous to estimate the position in an improved way using the conventional estimator. Different estimators can thus be applied iteratively. The intensity distribution in the form of a donut does not only refer to a simple 2D donut, but also to a 3D donut, for example to a 3D donut which is known as a bottle beam. In the focal plane, a 3D donut has an intensity distribution that is similar to the intensity distribution of a 2D donut. Therefore, the estimator can be used in conjunction with a 2D donut as well as in conjunction with a 3D donut to determine a lateral position. The axial position can then be determined in a conventional manner using the 3D donut.

According to one aspect, a difference is determined or a ratio is formed for the comparison. Equivalent to forming a difference between two vector sums, a vector sum can also be formed with summands with positive and summands with negative weights. In accordance with formula (1), the associated estimated values u₀ and u₁ can be determined for at least two subsets of the set of target coordinates, which comprise at least partially different target coordinates. The absolute difference d=|u₀−u₁| of these two functions also depends on x. However, the value range for |x|, for which an injective function x→d(x) is present, extends beyond xₗᵢₘ. The value d can therefore be used directly as an estimate for the radial distance of the position of an emitter from the center of the set of target coordinates. However, it can also be used to decide on which side of xₗᵢₘ the emitter or reflector is located. To reduce the required additional effort, the position of the emitter or reflector can be determined directly from the mean value of u₀ and u₁, which is usually a good approximation, instead of also calculating u for the entire set of target coordinates. Instead of calculating the difference, a ratio of the estimated values u₀ and u₁ can also be calculated to extend the usable range.

According to an aspect, the set of target coordinates comprises four or more target coordinates and the subsets of the set of target coordinates each comprise three or more target coordinates. At least three target coordinates are required to estimate a position. To form two non-identical subsets from the set of target coordinates, the set of target coordinates must therefore comprise at least four target coordinates. Increasing the number of target coordinates increases the isotropy of the localization accuracy.

According to one aspect, the subsets of the set of target coordinates are disjoint. In this way, the subsets have independent information content.

According to one aspect, the set of target coordinates comprises six target coordinates arranged in a hexagon. In this case, the subsets of the set of target coordinates preferably each comprise three target coordinates arranged in an equilateral triangle. By using six target coordinates arranged in a hexagon, very uniform localization accuracy is achieved regardless of the angular position of the emitter or reflector.

According to one aspect, a depth information for the emitter or reflector is determined from the vector sums and/or sums over vectors of the detected fluorescence photons or reflected photons determined for the subsets of the set of target coordinates. In this way, in addition to localization of the emitter or reflector in a plane perpendicular to the optical axis, localization along the optical axis is also performed without having to shift a focal plane relative to the sample.

According to one aspect, a combined vortex and trefoil phase is imposed on the excitation light to generate the intensity distribution. This is preferably done by means of an adjustable spatial light modulator (SLM). The phase shift of the trefoil phase is, for example, between 10% and 200% of the phase shift of the vortex phase, preferably between 20% and 150%, more preferably between 30% and 120%, more preferably between 80% and 110%, preferably 100%. By combining a vortex phase and a trefoil phase, an intensity distribution can be easily generated which is particularly suitable for determining depth information for the emitter or reflector. The ratio of the phase shifts particularly influences the lateral position of the local maxima relative to the optical axis as well as the distance of the local maxima along the optical axis. The larger the phase shift of the trefoil phase, the further the local maxima move outwards. At the same time, their length increases. The use of an adjustable surface light modulator has the advantage that the imposed phases can be adjusted as required.

According to one aspect, the central minimum is extended along the optical axis. This has the advantage that the depth information for the emitter or reflector can be reliably determined over a comparatively large depth range.

According to one aspect, the angular positions of the three or more local maxima change monotonically, preferably strictly monotonically, along the optical axis, further preferably proportional to the axial position. This simplifies the determination of the depth information for the emitter or reflector from the determined vector sums and/or sums over vectors of the detected fluorescence photons or reflected photons.

According to one aspect, the three or more local maxima are evenly distributed around the central minimum. Preferably, the angular positions of the three or more local maxima change along the optical axis over an intended axial detection range [z;-z] by an amount corresponding to 180° divided by the number of maxima. In the case of three local maxima, the angular position of each maximum thus changes by 60° from z to −z. If the number and position of the target coordinates of the target coordinate pattern is matched to the number and position of the local maxima, it can be achieved in this way that the emitter or reflector is subjected to an intensity that is a function of the axial position of the emitter or reflector with a maximized value range. In particular, it is advantageous if the number of target coordinates is twice as large as the number of local maxima.

Preferably, a microscope uses an apparatus or a method according to the present principles for estimating a position of an emitter or reflector in a sample.

### BRIEF DESCRIPTION OF THE DRAWINGS

Further features will be apparent from the following description and the appended claims in conjunction with the figures.

FIG. 1 schematically shows a method for estimating a position of an emitter or reflector in a sample;

FIG. 2 shows a first embodiment of an apparatus for estimating a position of an emitter or reflector in a sample;

FIG. 3 shows a second embodiment of an apparatus for estimating a position of an emitter or reflector in a sample;

FIG. 4 shows a sample with a plurality of emitters or reflectors;

FIG. 5 shows a principle structure of a MINFLUX microscope in which a solution according to the present principles is implemented;

FIG. 6 shows an example of a hexagonal target coordinate pattern;

FIG. 7 shows an example of position estimations for a group of simulated emitters;

FIG. 8 shows an intensity distribution of the excitation light in the x-y plane for different axial positions;

FIG. 9 shows the intensity distribution of the excitation light in the x-z plane;

FIG. 10 shows the intensity distribution of the excitation light in the y-z plane;

FIG. 11 shows an example of the generation of a light distribution in the form of a 3D donut, which has a zero point limited in three spatial directions;

FIG. 12 shows the value of an uncalibrated estimator according to the present principles in dependence on the position in a lateral plane for different axial positions;

FIGS. 13-15 show simulations of the behavior of an estimator according to the present principles and an estimator according to the prior art for different axial positions and a diameter of the target coordinate pattern of L=486 nm;

FIGS. 16-18 show corresponding simulations for a diameter of the target coordinate pattern of L=288 nm; and

FIGS. 19-21 show simulations of the behavior of a further estimator according to the present principles and an estimator according to the prior art for different axial positions and a diameter of the target coordinate pattern of L=486 nm.

### DETAILED DESCRIPTION OF PREFERRED EMBODIMENTS

For a better understanding of the principles of the present disclosure, embodiments will be explained in more detail below with reference to the figures. It is understood that the disclosure is not limited to these embodiments and that the features described may also be combined or modified without departing from the scope of protection of the disclosure as defined in the appended claims.

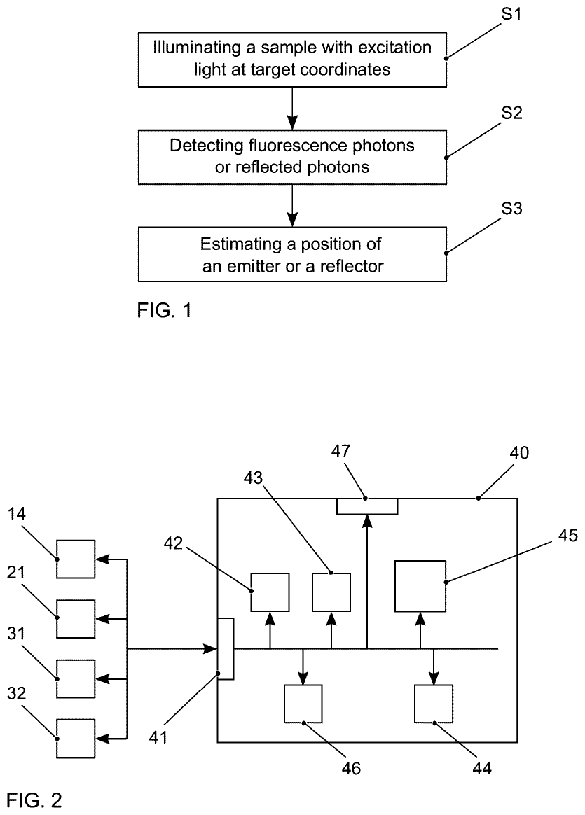

FIG. 1 schematically shows a method for estimating a position of an emitter or reflector in a sample. In the method, the sample is illuminated S1 with excitation light at at least one set of target coordinates. Fluorescence photons or reflected photons are detected S2 for the individual target coordinates of the set of target coordinates. A position of an emitter or reflector is estimated S3 from the detected fluorescence photons or reflected photons. The estimation S3 of the position of the emitter or reflector comprises a comparison of vector sums and/or sums over vectors of the detected fluorescence photons or reflected photons determined for subsets of the set of target coordinates. For example, a difference can be determined or a ratio can be formed for the comparison. In particular, the vector sums can be weighted vector sums. Alternatively or additionally, the excitation light has an intensity distribution having a central minimum and three or more local maxima arranged around the central minimum, wherein the angular positions of the three or more local maxima change along the optical axis. The vector sums and/or sums over vectors of the detected fluorescence photons or reflected photons determined for the subsets of the set of target coordinates can be used in conjunction with such an intensity distribution to determine depth information for the emitter or reflector. To generate the intensity distribution, a combined vortex and trefoil phase can be imposed on the excitation light, for example by means of an adjustable spatial light modulator.

FIG. 2 shows a simplified schematic representation of a first embodiment of an apparatus 40 for estimating a position of an emitter or reflector in a sample. The apparatus 40 has an interface 41 for communication with external components. Illuminating means 42 are configured to illuminate the sample with excitation light at at least one set of target coordinates. For this purpose, the illuminating means 42 can control a light source 14 and a spatial light modulator 21 via the interface 41. Detecting means 43 are configured to detect fluorescence photons or reflected photons for the individual target coordinates of the set of target coordinates. For this purpose, the detecting means 43 can evaluate signals from photodiodes 31, 32 that are received via the interface 41. The photodiodes 31, 32 may be avalanche photodiodes, for example. An estimating means 44 is configured to estimate a position of an emitter or reflector from the detected fluorescence photons or reflected photons. For this purpose, the estimating means 44 compares vector sums and/or sums over vectors of the detected fluorescence photons or reflected photons determined for subsets of the set of target coordinates. For the comparison, the estimating means 44 can, for example, determine a difference or form a ratio. In particular, the vector sums can be weighted vector sums. Alternatively or additionally, the excitation light has an intensity distribution having a central minimum and three or more local maxima arranged around the central minimum, wherein the angular positions of the three or more local maxima change along the optical axis. From the vector sums and/or sums over vectors of the detected fluorescence photons or reflected photons determined for the subsets of the set of target coordinates, the estimating means 44 can determine depth information for the emitter or reflector in conjunction with such an intensity distribution. To generate the intensity distribution, a combined vortex and trefoil phase can be imposed on the excitation light, for example by means of the spatial light modulator 21.

The illuminating means 42, the detecting means 43, and the estimating means 44 can be controlled by a control unit 45. If necessary, settings of the illuminating means 42, the detecting means 43, the estimating means 44, or the control unit 45 can be changed via a user interface 47. If required, the data generated in the apparatus 40 can be stored in a memory 46 of the apparatus 40, for example for later evaluation or for use by the components of the apparatus 40. The illuminating means 42, the detecting means 43, the estimating means 44, and the control unit 45 can be realized as dedicated hardware, for example as integrated circuits. Of course, they can also be partially or completely combined or implemented as software running on a suitable processor, for example on a GPU or a CPU. The interface 41 can also be implemented in the form of separate inputs and outputs.

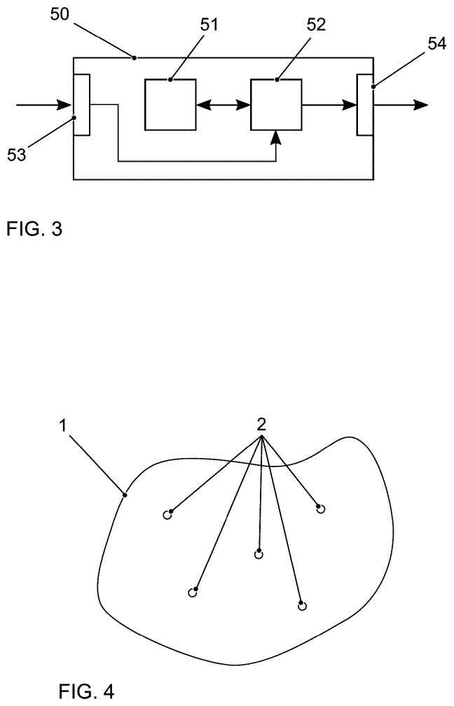

FIG. 3 shows a simplified schematic diagram of a second embodiment of an apparatus 50 for estimating a position of an emitter or reflector in a sample. The apparatus 50 comprises a processor 52 and a memory 51. For example, the apparatus 50 is a microcontroller, a computer, or an embedded system. The memory 51 stores instructions that, when executed by the processor 52, cause the apparatus 50 to perform the steps according to one of the described methods. The instructions stored in the memory 51 thus embody a program executable by the processor 52, which implements the method according to the present principles. The apparatus 50 has an input 53 for receiving information. Data generated by the processor 52 is provided via an output 54. In addition, they can be stored in the memory 51. The input 53 and the output 54 can be combined to form a bidirectional interface.

The processor 52 may include one or more processing units, such as microprocessors, digital signal processors, or combinations thereof.

The memories 46, 51 of the described embodiments may include both volatile and non-volatile memory regions and may include a wide variety of storage devices and storage media, such as hard disks, optical storage media, or semiconductor memories.

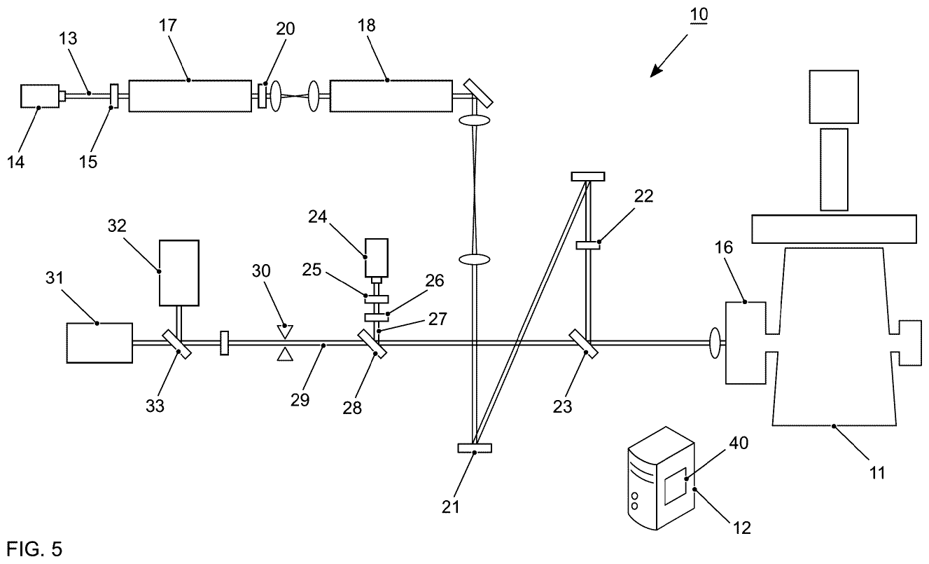

FIG. 4 shows a sample 1 with a plurality of emitters or reflectors 2. Five emitters or reflectors 2 are shown as examples. The emitters 2 can, for example, be fluorophores or molecules labeled with fluorophores. The fluorophores can be excited with light of a suitable wavelength to emit photons. In MINFLUX microscopy, the fluorophores are excited in such a way that a fluorophore to be localized is always placed close to or in a minimum of a light distribution used for excitation, whereby the light distribution must have a region with an intensity increase adjacent to the minimum. In this way, a better utilization of the fluorescence photons is achieved with respect to obtaining information about the position of the respective emitting fluorophore. Ideally, the minimum of the excitation light distribution is a zero point.

FIG. 5 shows a basic structure of a MINFLUX microscope 10 in which a solution according to the present principles is realized. The optical setup is based on a conventional fluorescence microscope. The realization of the MINFLUX concept on a standard inverted microscope platform 11 facilitates a practicable implementation of the high resolution, since a common fluorescence microscope provides all routinely required functions, such as compatibility with standard stages, sample holders, brightfield and epifluorescence illumination with insertable filters and eyepieces for rapid inspection of large areas of interest in the sample. The MINFLUX microscope 10 is controlled by a controller 12.

An excitation light beam 13 emitted by a laser 14 is focused into the focal plane of an objective lens that is part of the microscope platform 11. To enable both flexible previews of large areas of interest and precise measurements in desired areas using the MINFLUX concept, beam scanning with respect to the stationary sample is realized by a combination of a galvanometer scanning unit 16 and electro-optical beam deflectors 17, 18 To enable lateral fast scanning for MINFLUX measurements in the x-y plane, the excitation light beam 13 passes through a λ/2 plate 15 and is deflected by two electro-optical beam deflectors 17, 18, which are arranged in series and rotated by 90° to their respective axes. A λ/2 plate 20 between the electro-optical beam deflectors 17, 18 rotates the polarization of the light beam by 90° to account for this rotation. The field of view in the focal plane accessible via the beam deflectors 17, 18 is small and is extended via an additional galvanometer scanning unit 16 on the camera port of the microscope platform 11. The galvanometer scanning unit 16 serves as a coarser basis for further finer and much faster electro-optical x and y displacements. A phase-modulating spatial light modulator 21 is used to impose the desired phases on the excitation light beam 13. A λ/4 plate 22 then forms a circular polarization of the excitation light. The excitation light beam 13 is then superimposed on the detection beam path with a beam splitter 23 and guided into the microscope platform 11 via the galvanometer scanning unit 16. The galvanometer scanning unit 16 and the electro-optical beam deflectors 17, 18 together serve to position the excitation light beam 13 in the microscope platform 11, either as a normally focused beam for confocal scanning or as a beam with an intensity distribution suitable for the MINFLUX concept.

An activation laser 24 is used to activate individual fluorophores. The intensity of this laser 24 can be reduced, if required, to the nanowatt range, depending on the sample or the fluorophores used, for example, using a neutral density filter 25. After passing through a λ/4 plate 26, the activation light beam 27 is superimposed with the detection beam path and the beam path of the excitation beam path by means of a beam splitter 28. The activation light beam 27 is fed to the microscope platform 11 without passing through the electro-optical beam deflectors 17, 18.

The fluorescence light 29 emitted by the sample is collected by the objective, scanned by the galvanometer scanning unit 16, passed through the aforementioned beam splitters 23, 28 and guided to a variable pinhole 30 for confocal detection with two avalanche photodiodes 31, 32, which detect photons in different spectral ranges defined by a dichroic mirror 33.

In order to estimate the positions of the emitters in the sample, the controller 12 comprises an apparatus 40 according to the present principles for estimating a position of an emitter or reflector.

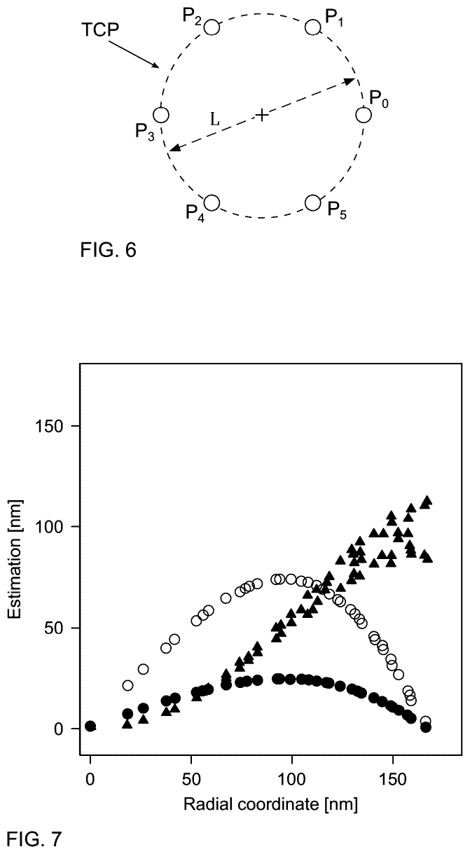

FIG. 6 shows an example of a hexagonal target coordinate pattern TCP. The target coordinate pattern TCP comprises target coordinates Pᵢ, at six positions 0 to 5, each symbolized by the open circles. The six target coordinates Pᵢ, lie on a circle with the diameter L. The center of the target coordinate pattern TCP is also marked, but it is not necessarily used as a target coordinate.

FIG. 7 shows examples of position estimations for a group of simulated emitters. The emitters each have a similar radial coordinate r. Plotted are estimates of r against the actual radial coordinate r for the hexagonal target coordinate pattern from FIG. 6. The filled circles show the mean uncalibrated estimate of the radial position, the open circles show the mean calibrated estimate of the radial position. The value of rₗᵢₘ, which can be read from the abscissa of the maxima of the two curves, is approx. 0,9×10⁻⁷ m. The values of d=|u₀−u₁|, which were determined for two subsets \vec{b}ᵢ(i=0,2,4) and \vec{b}ᵢ(i=1,3,5) of the target coordinate pattern, each with three target coordinates arranged in a triangle, are also shown using filled triangles. d(rₗᵢₘ) is approx. 50. The difference d between the values of the two subsets fans out, because for an estimator based on only three points the estimated radial coordinate also depends more strongly on the angular position. However, it is clearly recognizable that the range of values for r, for which an injective function r→d(r) is present, extends beyond rₗᵢₘ.

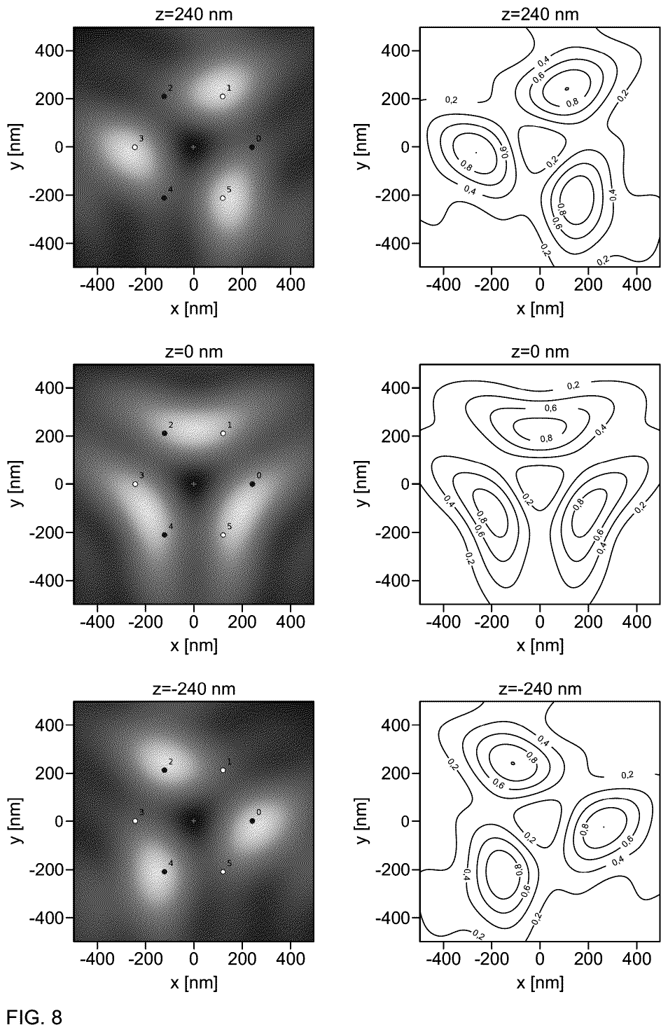

FIG. 8 to FIG. 10 show a special intensity distribution of the excitation light that allows the z-coordinate to be determined additionally without shifting the focal plane relative to the sample. The intensity distribution has a central minimum and three or more local maxima arranged around the central minimum, wherein the angular positions of the three or more local maxima change along the optical axis. To generate such an intensity distribution, a combined vortex and trefoil phase can be imposed on the excitation beam, e.g. by means of a spatial light modulator. Based on the donut caused by the vortex phase, the intensity distribution resulting from the combination can be referred to as a trenut.

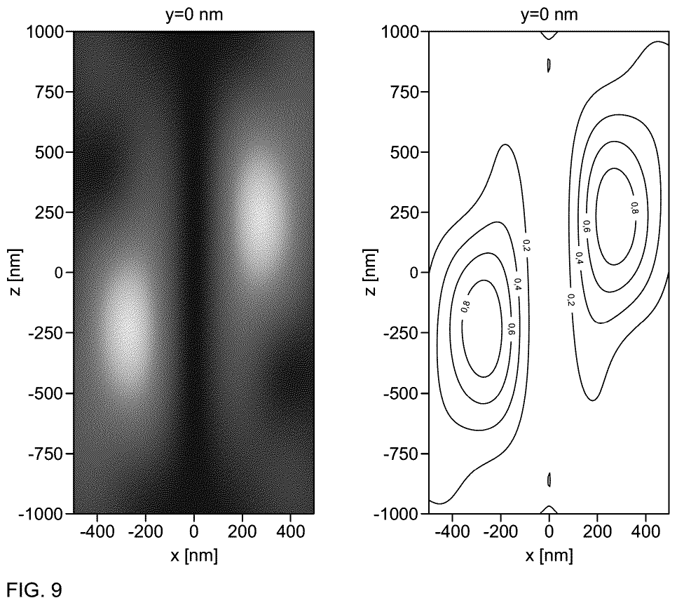

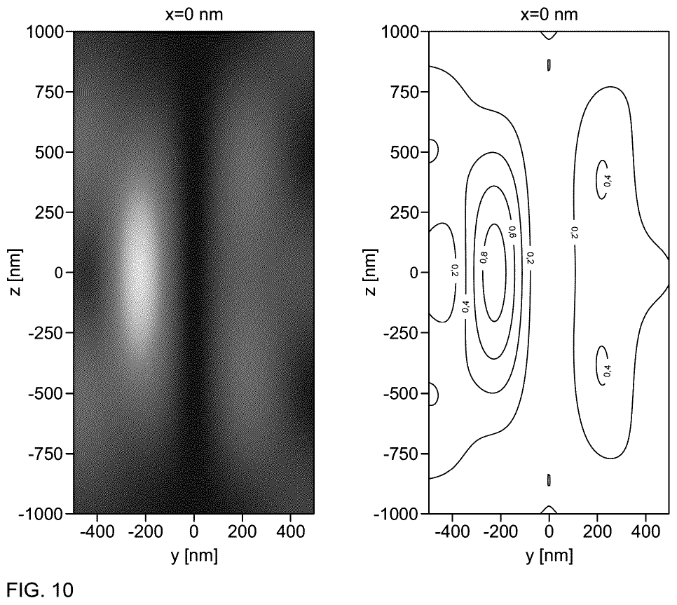

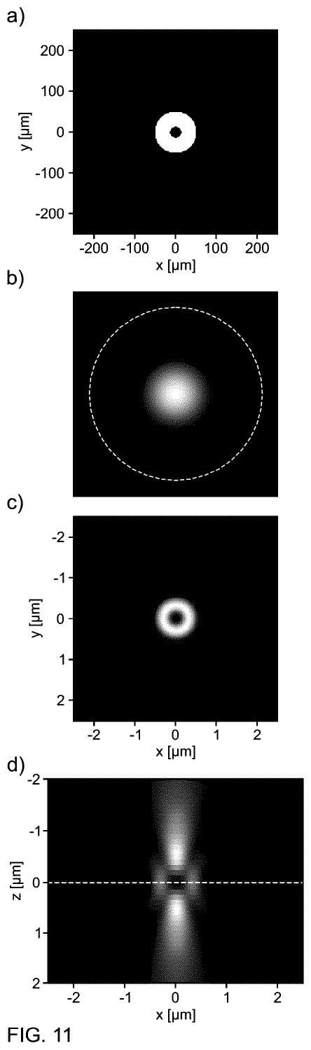

FIG. 8 shows the intensity distribution of the excitation light in the x-y plane for different axial positions. The intensity distributions are shown for three axial positions z=−240 nm, z=0 nm and z=240 nm for a wavelength of 642 nm and a numerical aperture NA=1.4. On the left, the intensity distribution is shown in gray scale, on the right as a contour plot. FIG. 9 and FIG. 10 show the intensity distribution of the excitation light in the x-z plane and the y-z plane. Also shown in FIG. 8 are the six positions 0 to 5 of the target coordinate pattern, which form two subsets α=(0,2,4) and β=(1,3,5). The diameter of the target coordinate pattern used, which is adapted to the position of the local maxima, is L=486 nm. The number of positions is matched to the number of local maxima. Preferably, the number of positions is twice as large as the number of local maxima, i.e. six positions for a trenut and correspondingly more positions for a multinut with more than three local maxima. The positions of the target coordinate pattern and the position of the local maxima are coordinated in such a way that for z=0 nm position pairs from the two subsets of the target coordinate pattern, e.g. the position pairs (1,2), (3,4) and (5,0), are each subjected to the same intensity. For increasing or decreasing values of z, the local maxima shift so that the positions of one of the two subsets are subjected to a high intensity, while the positions of the other subset are subjected to a low intensity. This can be clearly seen in FIG. 8 in the intensity distributions for the axial positions =−240 nm and z=240 nm.

Assuming now that a fluorophore is located in the center of the target coordinate pattern at position (0,0,0) and the center of the intensity distribution is shifted to the right to position 0 of the target coordinate pattern, then the fluorophore is exposed to the intensity that belongs to position 3 of the target coordinate pattern in the representation of the non-shifted intensity distribution. The same applies to pairs 1-4 and 2-5 and vice versa. If a fluorophore is scanned at a target coordinate pattern with the points 0 to 5, the corresponding intensities can be read from the figure. Of course, this also applies to fluorophores with axial positions not equal to 0.

If a fluorophore is located laterally in the center, then it is exposed to the intensity seen at point 3 in FIG. 8 for point 0 of the target coordinate pattern, at point 4 with the intensity of point 1, at point 2 with the intensity of point 5 and correspondingly 1-4, 3-0, 5-2. It can already be seen from FIG. 8 that such a fluorophore at z=240 nm is exposed to the small intensities of points 4,2,0 at the odd points 1,3,5 of the target coordinate pattern and correspondingly to the large intensities of points 1,3,5 at the even points 0,2,4 of the target coordinate pattern. At z=0 nm, on the other hand, it is exposed to the same intensities in each case. At z=−240 nm, the situation is exactly the opposite of that at z=240 nm. The diameter L of the target coordinate pattern used ensures that the fluorophore is exposed to an intensity that is strongly dependent on the axial position z in the observed range from z=240 nm to z=−240 nm. Something similar also applies if the fluorophore is not exactly on the axis. Consequently, a z-coordinate can be easily estimated with the Trenut using a position estimation based on subsets of the target coordinate pattern. FIG. 8 clearly shows that the intensity distribution near the axis behaves quite nicely, so that a lateral position determination can be performed following an axial position determination with a smaller diameter L of the target coordinate pattern, e.g. with L=288 nm.

FIG. 11 shows an example of the generation of a light distribution in the form of a 3D donut. FIG. 11a) shows a structure realized with a first light modulator, in this case a ring structure. FIG. 11b) shows the corresponding situation in the Fourier plane. In the plane of the sample, the result is the image shown in FIG. 11c). The central intensity minimum is surrounded on all sides by an intensity maximum. In the axial direction, i.e. in the beam propagation direction, the intensity profile shown in FIG. 11d) as a section in the xz-plane is obtained. As can be clearly seen, the light distribution also has an intensity minimum in the axial direction, to which regions with intensity increase are adjacent. The light distribution thus allows position determination in three dimensions. For this purpose, the sample can be moved in the axial direction, for example. Alternatively, an additional dynamically focusing element can be arranged in the beam path, with which the light distributions can be shifted in the axial direction, e.g. a deformable mirror.

Analogous to the above formula (1), an uncalibrated estimator based on a trenut for the subsets α=(0,2,4) and β=(1,3,5) of the positions \vec{b}ᵢ of the target coordinate pattern can be formulated as:

$${\vec{{u}^{′}}}_{xy} ( \vec{x} , {\vec{b}}_{i} ) := \vec{u} ( \vec{x} , {\vec{b}}_{i} , i ∈ a ) - \vec{u} ( \vec{x} , {\vec{b}}_{i} , i ∈ β ) {\vec{{u}^{′}}}_{z} ( \vec{x} , {\vec{b}}_{i} ) := \frac{{\sum }_{i ∈ α} {p}_{i} - {\sum }_{i ∈ β} {p}_{i}}{{\sum }_{i} {p}_{i}} . \qquad ( 2 )$$

The two summands \vec{u}(\vec{x}, \vec{b}ᵢ, i∈α) and \vec{u}(\vec{x}, \vec{b}ᵢ, i∈β) are formed according to formula (1), i.e. for \vec{u′}_{xy}(\vec{x}, \vec{b}ᵢ) only the photon counts of the respective subset of the target coordinate pattern are summed in the denominator.

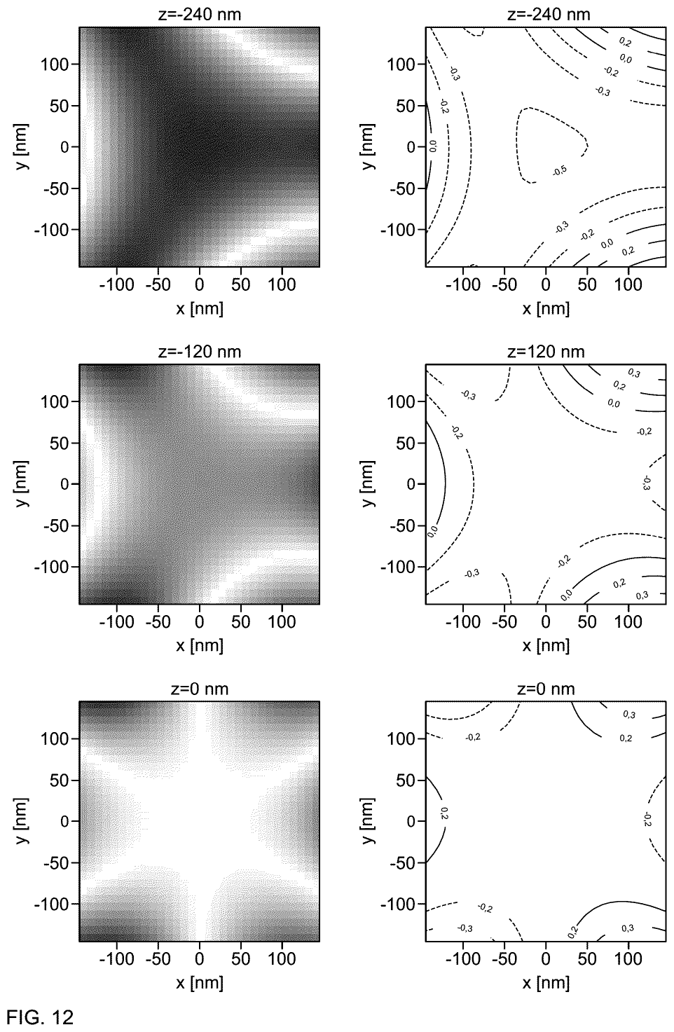

FIG. 12 shows on the right-hand side the value of the uncalibrated estimator \vec{u′}_{z} as a function of the position in a lateral plane for z=−240 nm, z=−120 nm, and z=0 nm using contour lines. On the left-hand side, the values are shown in gray-scale code. In particular, the gray-scale coded representation clearly shows that an axial coordinate of the fluorophores can be easily determined even without precise knowledge of the lateral position. In order that the asymmetry of the intensity distribution can be used to determine the axial position, the diameter of the target coordinate pattern is adapted to the position of the local maxima.

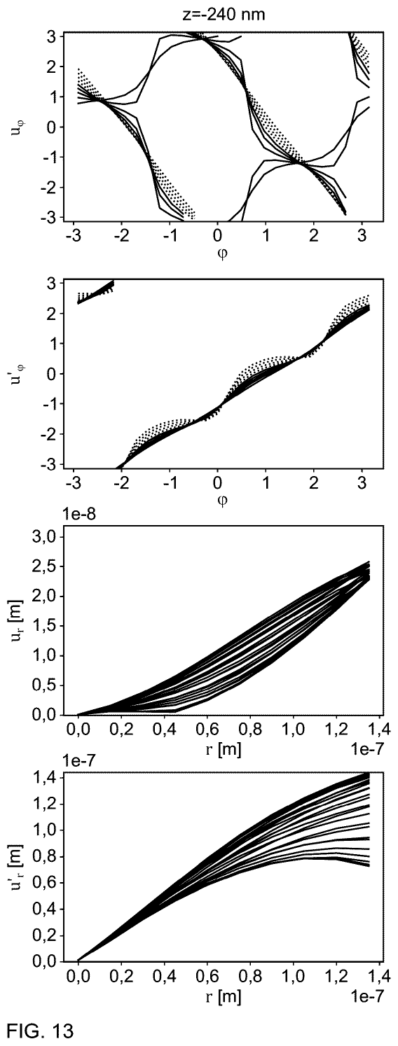

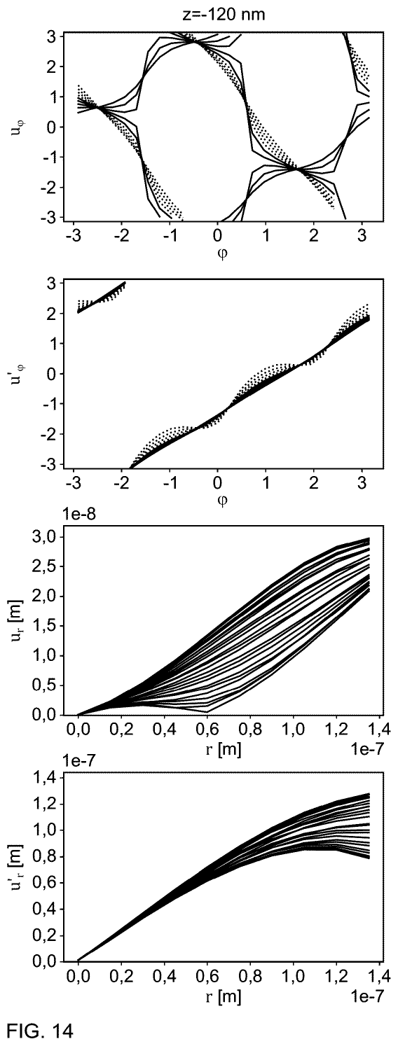

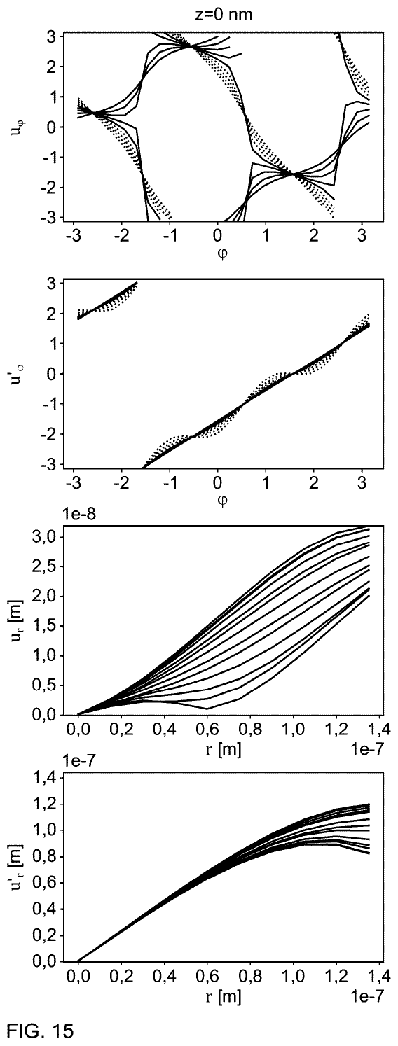

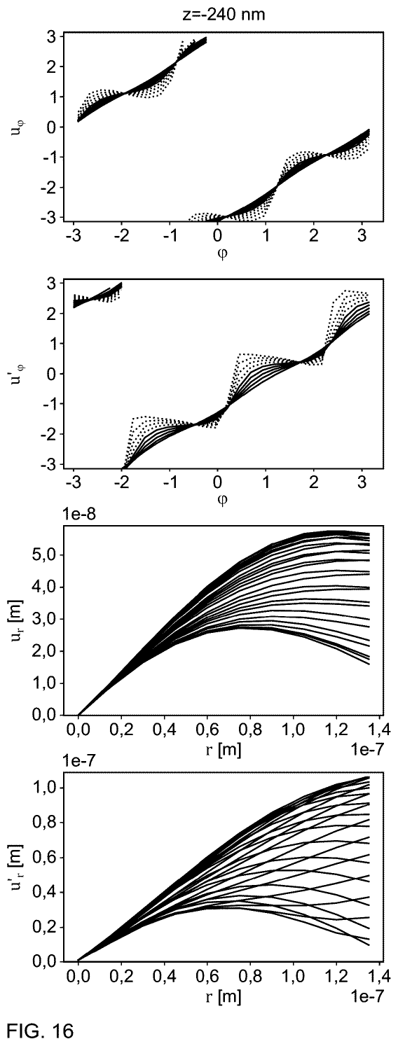

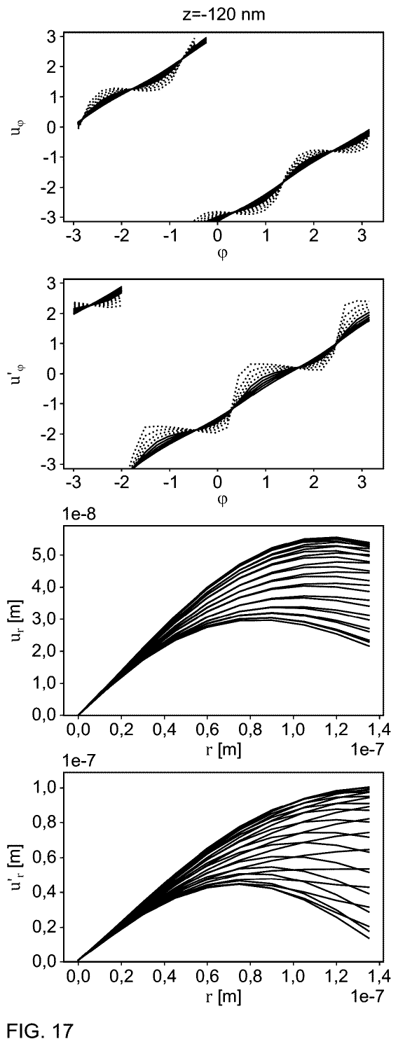

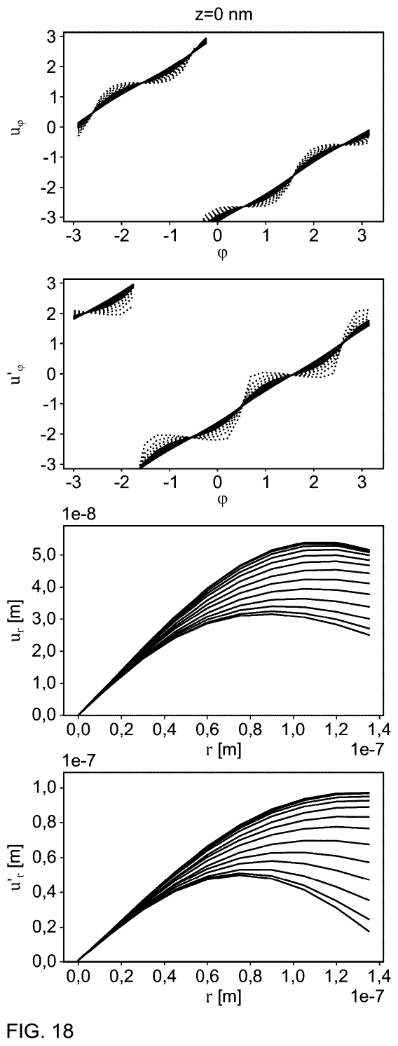

FIG. 13 to FIG. 15 show simulations of the behavior of the estimator u according to formula (1) and of the estimator u′ according to formula (2) for the axial positions z=−240 nm, z=−120 nm, and z=0 nm. The simulations are based on a wavelength of 642 nm and a diameter of the target coordinate pattern of L=486 nm. The figures show, from top to bottom, the uncalibrated estimate of the angular position φ with the estimator u, the uncalibrated estimate of the angular position φ with the estimator u′, the uncalibrated estimate of the radial position r with the estimator u, and the uncalibrated estimate of the radial position r with the estimator u′. FIG. 16 to FIG. 18 show corresponding simulations for a diameter of the target coordinate pattern of L=288 nm. As can be clearly seen from the figures, the behavior of u and u′ depends very much on the choice of the diameter L. The more benevolent the behavior of the estimators, i.e. the larger the injective range, the larger the effective measurement range. For a typical measuring range of r≤75 nm, the curves for positions of emitters or reflectors within this range are shown as solid lines, while those outside this range are shown as dashed lines. This makes it much easier to assess the injectivity in the relevant range. In relation to the angular coordinate φ, the estimator u′ is injective over the entire range from −πto +π. The diameter L=486 nm is optimized for a determination of Z. The estimator u′ behaves much more benevolent than the estimator u. The diameter L=288 nm leads to an inaccurate determination of z, so that the use of the estimator u′ is necessary for this. The coordinates x and y or r and φ can also be determined well with the estimator u.

As an alternative to the above formula (2), an uncalibrated estimator based on a trenut for the subsets α=(0,2,4) and β=(1,3,5) of the positions \vec{b}ᵢ of the target coordinate pattern can also be formulated as:

$${\vec{{u}^{′}}}_{xy} ( \vec{x} , {\vec{b}}_{i} ) := \frac{{\sum }_{j ∈ α} {p}_{j} {\vec{b}}_{j} - {\sum }_{k ∈ β} {p}_{k} {\vec{b}}_{k}}{{\sum }_{i} {p}_{i}} {\vec{{u}^{′}}}_{z} ( \vec{x} , {\vec{b}}_{i} ) := \frac{{\sum }_{i ∈ α} {p}_{i} - {\sum }_{i ∈ β} {p}_{i}}{{\sum }_{i} {p}_{i}} . \qquad ( 3 )$$

In this case, for \vec{u′}_{xy}(\vec{x}, \vec{b}ᵢ) in the denominator the sum is formed over the photon counts of all positions of the target coordinate pattern.

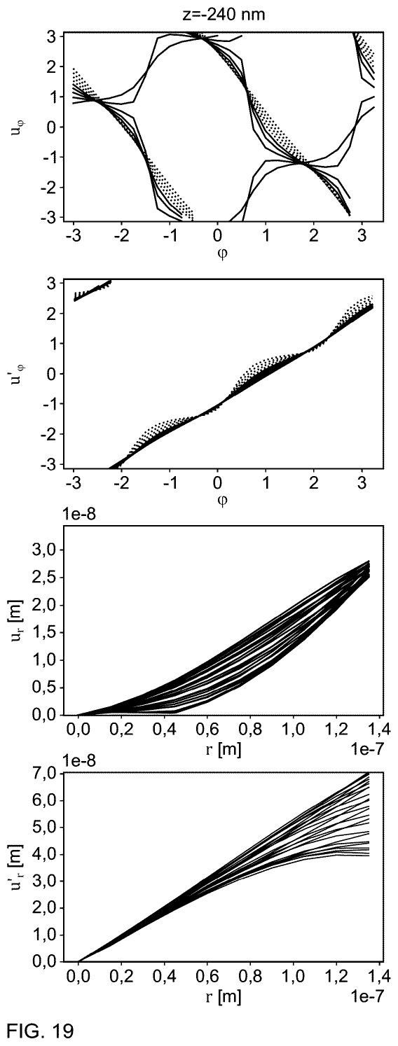

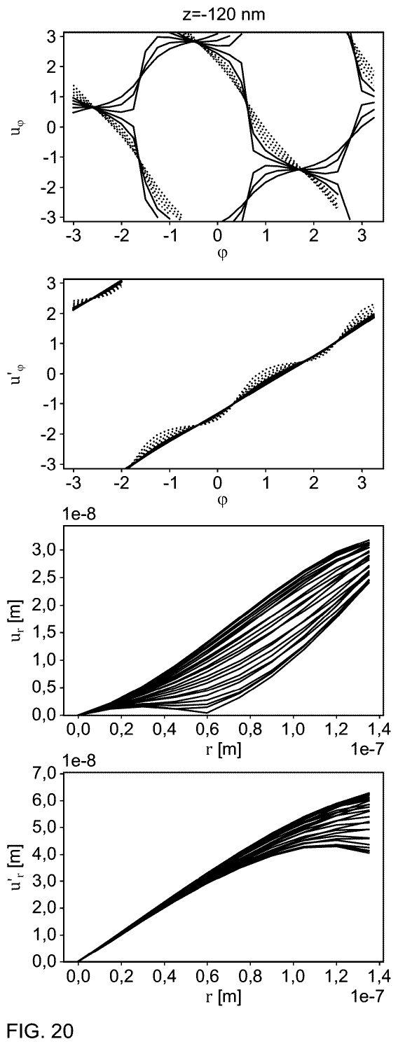

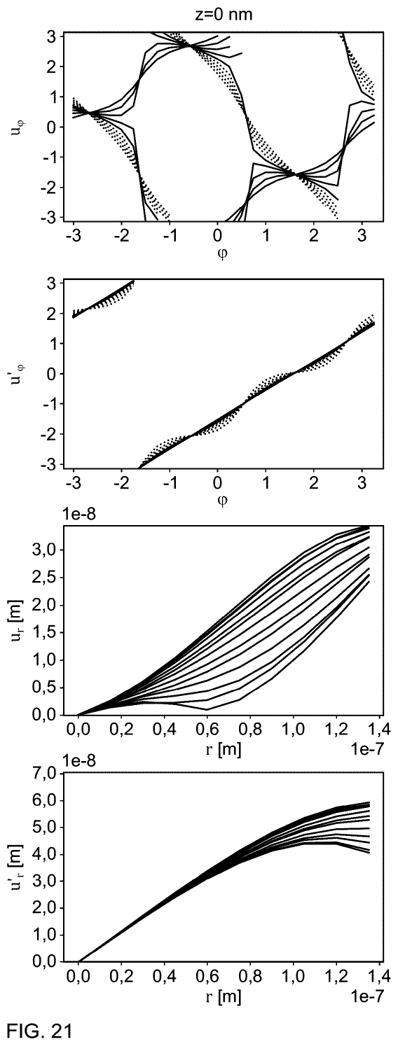

FIG. 19 to FIG. 21 show simulations of the behavior of the estimator u according to formula (1) and of the further estimator u′ according to the present principles according to formula (3) for the axial positions =−240 nm, z=−120 nm, and z=0 nm. The simulations are based on a wavelength of 642 nm and a diameter of the target coordinate pattern of L=486 nm. The figures show, from top to bottom, the uncalibrated estimate of the angular position φ with the estimator u, the uncalibrated estimate of the angular position φ with the estimator u′, the uncalibrated estimate of the radial position r with the estimator u, and the uncalibrated estimate of the radial position r with the estimator u′. As can be seen from the figures, the estimator according to formula (3) behaves somewhat more benevolent than the estimator according to formula (2).

1. A method for estimating a position of an emitter or reflector in a sample, comprising:
illuminating the sample with excitation light at at least one set of target coordinates, wherein the excitation light has an intensity distribution in the form of a donut;
detecting fluorescence photons or reflected photons for the individual target coordinates of the set of target coordinates;
determining a first estimated position of an emitter or reflector from the fluorescence photons or reflected photons detected for a first subset of the set of target coordinates;
determining a second estimated position of the emitter or reflector from the fluorescence photons or reflected photons detected for a second subset of the set of target coordinates; and
estimating a position of the emitter or reflector by comparing the first estimated position and the second estimated position.

2. The method according to claim 1, wherein the first estimated position and the second estimated position are uncalibrated and the position estimated by comparing the first estimated position and the second estimated position is calibrated.

3. The method according to claim 1, wherein a difference is determined for the comparison.

4. The method according to claim 1, wherein the set of target coordinates comprises four or more target coordinates and the subsets of the set of target coordinates each comprise three or more target coordinates.

5. The method according to claim 1, wherein the subsets of the set of target coordinates are disjoint.

6. The method according to claim 1, wherein the set of target coordinates comprises six target coordinates arranged in a hexagon.

7. The method according to claim 6, wherein the subsets of the set of target coordinates each comprise three target coordinates arranged in an equilateral triangle.

8. The method according to claim 2, wherein a difference is determined for the comparison.

9. The method according to claim 2, wherein the set of target coordinates comprises four or more target coordinates and the subsets of the set of target coordinates each comprise three or more target coordinates.

10. The method according to claim 2, wherein the subsets of the set of target coordinates are disjoint.

11. The method according to claim 2, wherein the set of target coordinates comprises six target coordinates arranged in a hexagon.

12. The method according to claim 11, wherein the subsets of the set of target coordinates each comprise three target coordinates arranged in an equilateral triangle.

13. A method for estimating a position of an emitter or reflector in a sample, comprising:
illuminating the sample with excitation light at at least one set of target coordinates;
detecting fluorescence photons or reflected photons for the individual target coordinates of the set of target coordinates; and
estimating a position of an emitter or reflector from the detected fluorescence photons or reflected photons;
wherein the excitation light has an intensity distribution comprising a central minimum and three or more local maxima arranged around the central minimum, wherein the angular positions of the three or more local maxima vary along the optical axis.

14. The method according to claim 13, wherein estimating the position of the emitter or reflector comprises comparing estimated positions for the emitter or reflector determined from fluorescence photons or reflected photons detected for subsets of the set of target coordinates.

15. The method according to claim 14, wherein a depth information for the emitter or reflector is determined from vector sums and/or sums over vectors of the detected fluorescence photons or reflected photons determined for the subsets of the set of target coordinates.

16. The method according 14, wherein a combined vortex and trefoil phase is imposed on the excitation light to generate the intensity distribution.

17. The method according to claim 16, wherein the combined vortex and trefoil phase is imposed on the excitation light by means of an adjustable spatial light modulator.

18. The method according to claim 16, wherein the phase shift of the trefoil phase is between 10% and 200% of the phase shift of the vortex phase, preferably between 20% and 150%, more preferably between 30% and 120%, more preferably between 80% and 110%, preferably 100%.

19. The method according to claim 14, wherein the central minimum is extended along the optical axis.

20. The method according to claim 14, wherein the angular positions of the three or more local maxima change monotonically, preferably strictly monotonically, along the optical axis, further preferably proportional to the axial position.

21. The method according to claim 14, wherein the three or more local maxima are evenly distributed around the central minimum.

22. The method according to claim 21, wherein the angular positions of the three or more local maxima change along the optical axis by an amount corresponding to 180° divided by the number of maxima.

23. A microscope comprising a controller, wherein the controller is configured to estimate a position of an emitter or reflector in a sample by:
illuminating the sample with excitation light at at least one set of target coordinates, wherein the excitation light has an intensity distribution in the form of a donut;
detecting fluorescence photons or reflected photons for the individual target coordinates of the set of target coordinates;
determining a first estimated position of an emitter or reflector from the fluorescence photons or reflected photons detected for a first subset of the set of target coordinates;
determining a second estimated position of the emitter or reflector from the fluorescence photons or reflected photons detected for a second subset of the set of target coordinates; and
estimating a position of the emitter or reflector by comparing the first estimated position and the second estimated position.

24. The microscope according to claim 23, wherein the first estimated position and the second estimated position are uncalibrated and the position estimated by comparing the first estimated position and the second estimated position is calibrated.

25. A microscope comprising a controller, wherein the controller is configured to estimate a position of an emitter or reflector in a sample by:
illuminating the sample with excitation light at at least one set of target coordinates;
detecting fluorescence photons or reflected photons for the individual target coordinates of the set of target coordinates; and
estimating a position of an emitter or reflector from the detected fluorescence photons or reflected photons;
wherein the excitation light has an intensity distribution comprising a central minimum and three or more local maxima arranged around the central minimum, wherein the angular positions of the three or more local maxima vary along the optical axis.

26. The microscope according to claim 25, wherein estimating the position of the emitter or reflector comprises comparing estimated positions for the emitter or reflector determined from fluorescence photons or reflected photons detected for subsets of the set of target coordinates.

27. The microscope according to claim 25, comprising an adjustable spatial light modulator for imposing a combined vortex and trefoil phase on the excitation light.
